(19) United States
(12) Patent Application Publication
(10) Pub. No.: US 2004/0032322 A1
(43) Pub. Date: Feb. 19, 2004

(54) Device for sensing lateral impact

(76) Inventors: Pascal Kocher, Ottrott (DE); Michael Arndt, Reutlingen (DE); Rolf-Juergen Recknagel, Jena (DE); Rolf Aidam, Woerth (DE)

Correspondence Address: KENYON & KENYON, ONE BROADWAY, NEW YORK, NY, 10004, US

(21) Appl. No.: 10/333,040

(22) PCT Filed: May 14, 2002
(86) PCT No.: PCT/DE02/01724

(30) Foreign Application Priority Data
May 16, 2001 (DE) 101 23 840.1

(51) Int. Cl. B60Q 1/00

(52) U.S. Cl. 340/436; 701/45; 180/274

(57) ABSTRACT

A system for side-impact detection is proposed which is distinguished in that both a temperature sensor as well as an acceleration sensor are accommodated in a structural unit. One of the sensors in each case is used for a plausibility check.

### BACKGROUND INFORMATION

The present invention is based on a system for side-impact detection according to the definition of the species in the independent patent claim.

From the non-published German Patent Application DE 100 57 258, it is already known to use a temperature sensor for sensing a side impact in a side panel of a motor vehicle and to use an acceleration sensor as a plausibility sensor.

### SUMMARY OF THE INVENTION

In contrast, the system for side-impact detection according to the present invention having the features of the independent claim has the advantage over the related art that the temperature sensor and the acceleration sensor are jointly accommodated in a structural unit. This reduces interfaces, sensor housing, cable assemblies and the installation cost. In this context, a structural unit is to be understood as a device which may be enclosed in a housing, the components not being connected to each other by long cables.

The measures and refinements specified in the dependent claims permit advantageous improvements of the system for side-impact detection in the independent claim.

It is particularly advantageous that the system transmits the sensor values of the temperature sensor and the acceleration sensor to the control device, so that the control device itself implements the evaluation of the sensor values. In this way, the system according to the present invention may be kept particularly simple since it requires no means to evaluate the sensor signals.

Furthermore, it is advantageous that the system includes a processor for evaluating at least one of the sensor signals, so that the sensor used as plausibility sensor, that is, either the acceleration sensor or the temperature sensor, is already checked in the system according to the present invention to ascertain whether the plausibility condition, that is, a threshold value, was exceeded or not. The result of this evaluation is then transmitted to the control device, which subsequently compares the result of the side-impact sensor with the plausibility sensor.

If both sensor values are transmitted, an interface component of the system according to the present invention then forms a multiplex of the sensor values. This may be a frequency multiplex or a time-division multiplex. But even if the system according to the present invention evaluates the sensor values of the plausibility sensor on its own, the interface component forms a multiplex from the result of this evaluation and the sensor values of the side-impact sensor.

Finally, it is also advantageous that the system according to the present invention has a common housing for the temperature sensor and the acceleration sensor. Both sensors are preferably produced in micromechanics technology and may even be located on the same substrate.

### BRIEF DESCRIPTION OF THE DRAWING

Exemplary embodiments of the present invention are shown in the drawings and are explained in greater detail in the following description.

The figures show:

FIG. 1 a first block diagram of two systems according to the present invention, which are connected to a control device.

FIG. 2 a second block diagram of the system according to the present invention.

### SPECIFICATION

Increasingly, side-impact sensors are utilized in motor vehicles to sense a side impact and then to deploy appropriate restraint means. In particular, these sensors for side-impact detection are used outside of the central control device, which is located on the tunnel of the vehicle, that is, inside side panels or on side panels of the motor vehicle. Among these locations are a cavity of the side panel, a seat lower cross member, a sill, the B-column or the door. With the aid of a digital interface, the sensor signals are then transmitted to the control device to be directly processed there.

Especially events that the side-impact sensor erroneously detected as a side crash, have to be eliminated by a plausibility sensor before they possibly result in a triggering of a side-air bag. Preferably, the plausibility sensor uses a different physical measuring principle than the actual side-impact sensor.

According to the present invention, a temperature sensor for side-impact detection is combined with an acceleration sensor for side-impact detection in a system representing a structural unit. This saves costs for cables, housings and costs at interface components, since these two sensors may now make joint use of an interface component and a housing.

At present, the sensors are generally produced in micromechanics technology, it also being possible to produce different sensor types, such as the temperature sensor and the acceleration sensor, on a common substrate. Here, remote sensors are connected, via a two-wire line, to the central control device on the tunnel. Moreover, a so-called power-line transmission is implemented here, that is, the control device provides the remote sensors with electrical energy via this two-wire line, whereas the sensors modulate this electric energy for data transmission, and these modulation signals are then received by the control device.

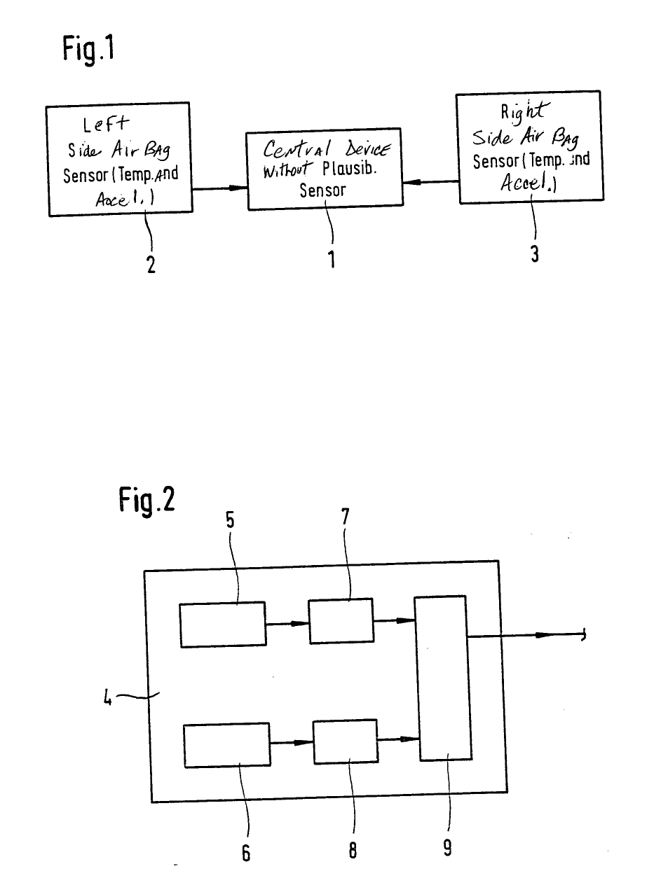

FIG. 1 shows a configuration as it may be provided in a motor vehicle for a left and a right side air bag. A central control device 1 without a plausibility sensor is located on a vehicle tunnel. Control device 1 is connected to a sensor system 2 via a first data input, and to a sensor system 3 via a second data input. Sensor system 2 is installed in a side panel on the left vehicle side, whereas sensor system 3 is located on the right side of the vehicle. Systems 2 and 3 are each located in a side panel designed as a cavity. Both sensor systems 2 and 3 are provided with a temperature as well as an acceleration sensor. If a side impact occurs, the side panel is indented, and the air in the cavity in which sensor systems 2 and 3 are each located, is compressed. This results in an adiabatic pressure increase and an accompanying adiabatic temperature rise. At the same time, the side impact causes an acceleration in the transverse direction.

Both the temperature increase as well as the acceleration in the transverse direction are detected by the temperature sensor or by the acceleration sensor. These respective sensor values are either directly transmitted to control device 1, or the sensor values of the plausibility sensor, i.e. either the temperature sensor or the acceleration sensor, are already evaluated in system 2 or 3 according to the present invention with respect to a threshold value by a processor or a dedicated hardware component. Only this result is then transmitted to central device 1. Central device 1, using the sensor that is not used as plausibility sensor, then calculates the triggering algorithm and checks whether the plausibility sensor also indicates a side impact, in case that this is the result of the triggering algorithm. In a triggering case, central device 1 activates the restraint means, not shown here, so as to trigger them and to protect the vehicle passengers in an appropriate manner.

FIG. 2 shows a block diagram of a system according to the present invention. System 4 according to the present invention is designed as a structural unit with a single housing. An acceleration sensor 5 including a measuring amplifier is connected to an analog-digital converter 7, which digitizes the acceleration values and transmits them to an interface component 9. An acceleration sensor 6 with a connected measuring amplifier is likewise connected to an analog-digital converter 8, which also digitizes the temperature signals and likewise transmits them to interface component 9. If the sensor values are transmitted directly to control device 1, interface component 9 forms a multiplex from the digitized acceleration and temperature signals, that is, either a time-division multiplex or a frequency-division multiplex.

If temperature sensor 5 is used as a plausibility sensor, interface component 9 is provided with a processing unit that compares the temperature signals of temperature sensor 5 to a predefined threshold value stored in interface component 9. If the temperature signals exceed this threshold value, plausibility sensor 5 indicates that a side impact was detected. Interface component 9 then transmits this result to central device 1. Acceleration sensor 6 is used as the side-impact sensor in this case, and the acceleration-sensor values are transmitted directly to central device 1. Here, too, however, interface component 9 forms a multiplex from the result of the plausibility check of the temperature signals and the acceleration values. Acceleration sensor 6 may be used as plausibility sensor as well. In that case, interface component 9 compares the acceleration values to a predefined threshold value, and a side impact is recognized only if this threshold value is exceeded. In this case, temperature sensor 5 transmits the temperature signals to control device 1 for calculation of the triggering algorithm.

What is claimed is:

1. A system for side-impact detection, the system being able to be connected to a control device (1) and comprising a temperature sensor (5) as well as an acceleration sensor (6) for side-impact detection, wherein the system (2, 3) is accommodated as a structural unit in a side panel of a vehicle designed as a cavity.

2. The system as recited in claim 1, wherein the system (2, 3) transmits sensor values of the temperature sensor (5) and the acceleration sensor (6) to the control device (1).

3. The system as recited in claim 1, wherein the system (2, 3, 4) includes a processor (9) for evaluating at least one of the sensor signals as a plausibility check and transmits a result of the plausibility check to the control device (1).

4. The system as recited in claim 2, wherein the system includes an interface component (9) for forming a multiplex from the sensor values.

5. The system as recited in one of the preceding claims, wherein the system (2, 3, 4) includes a common housing for the temperature sensor and the acceleration sensor.
